(19) United States
(12) Patent Application Publication
(10) Pub. No.: US 2024/0027132 A1
(43) Pub. Date: Jan. 25, 2024

(54) Screw conveyor

(71) Applicant: Carmine Elia, Pomezia (IT)

(72) Inventor: Carmine Elia, Pomezia (IT)

(21) Appl. No.: 18/256,262

(22) PCT Filed: Dec. 7, 2021
(86) PCT No.: PCT/EP2021/084627

§ 371 Date: Jun. 7, 2023

(30) Foreign Application Priority Data
Dec. 7, 2020 (IT) 102020000030089

(51) Int. Cl. F26B 17/20; F26B 3/04; F26B 21/04; F26B 21/08; F26B 25/00; B65G 33/26

(52) U.S. Cl. CPC F26B 17/205; F26B 3/04; F26B 21/04; F26B 21/086; F26B 25/005; B65G 33/265; F26B 2200/18; F26B 2200/02

(57) ABSTRACT

A screw conveyor (90, 91, 92) for a drying apparatus (1) or a fermentation system is disclosed. The screw conveyor includes a helical element (11) having a longitudinal axis (x) and including a primary spiral (12) and a secondary spiral (13) mounted on the primary spiral and rotatable with respect to the primary spiral around the longitudinal axis; and a set of elongated members (20) spanning the primary and secondary spirals.

### FIELD

The present invention relates to a screw conveyor for particular, but not exclusive, use in a drying apparatus or fermentation system.

### BACKGROUND

U.S. Pat. No. 5,561,917 A describes a slurry dryer comprising a rotatable drum at the inside of which, a feed screw provided with gripping fins is attached. Initially, a screw conveys the slurry to the drum through a slurry inlet into the drum. The drum rotates, while the feed screw and gripping fins transport the slurry to be treated from the drum inlet to the drum outlet. The drum has a completely solid cylindrical outer wall.

Spiral dryers consisting of a perforated drum on whose inner surface a screw is integrally attached are known.

KR 200280671 discloses a drier device for drying a variety of waste. The waste is introduced through an inlet hopper and a waste shredder into a drying chamber, within which a plurality of screw conveyors moves, each comprising a helical element and a trough. Screw conveyors transport the dried waste as it moves toward a drying chamber exit. The dried waste is conveyed to an incinerator. The screw conveyors have vanes fixed between a first and a second loop of helical element. The vanes, which are inclined at a preset angle relative to the longitudinal direction, are intended to transport and crush the waste.

Since the vanes are rigidly attached to the loops of the helical element, it is not feasible to change their position to adapt to different types of substance to be treated. The materials differ in their characteristics, especially in terms of quality and quantity, and therefore need specific mixing times for their drying and residence times in the conveyor to reach the desired humidity. Since the position of the vanes of the screw conveyors is fixed between each loop of the helical element, it is not feasible to optimize the drying process for each particular type of substance to be treated.

### SUMMARY

According to a first aspect of the present invention there is provided a screw conveyor. The screw conveyor comprises a helical element (or “a screw blade assembly”) having a longitudinal axis. The screw conveyor comprises a primary spiral (or “first screw blade”) and a secondary spiral (“or second screw blade”) mounted on the primary spiral and rotatable with respect to the primary spiral around the longitudinal axis. The screw conveyor comprises a set of elongate members spanning the primary and secondary spirals.

Thus, by rotating the secondary spiral with respect to the first spiral, the angle of inclination of the elongate members can be varied and so allow the screw conveyor to adapt to different scenarios and different types of substances conveyed by and/or treated in the screw conveyor.

The helical element may be configured such that the secondary spiral is rotatable with respect to the first spiral between a lower angular limit up and an upper angular limit. The difference between the lower angular limit and the upper angular limit may be between 20° and 40°, preferably between 25° and 35°. The lower angular limit may be 0° and the upper angular limit may be between 20° and 40°. The lower angular limit may be between −10° and −20° and the upper angular limit may be between 10° and 20°.

The primary and secondary spirals may be intertwined. The primary and secondary spirals are may be coaxial. The secondary spiral may abut the primary spiral. The turns of the primary and secondary spirals may match. The pitch of the primary and secondary spirals may be the same. The helical element may have a plurality of turns. The number of turns in the primary and secondary spirals may be the same as the number of turns in the helical element. The number turns in the primary and secondary spirals may be the same for the majority (i.e., more than so %) of the length of the helical element or substantially all (i.e., more than 90%) of the length of the helical element.

The elongate members may be off-axis (i.e., off the longitudinal axis). The ends of the elongate members may be disposed proximate to outer peripheries of the turns of the primary and secondary spirals. At least one elongate member may have two ends of which a first end may be positioned on a first turn of the helical element and a second end may be positioned on a second turn facing the first turn.

A first end of an elongate member may be hingedly attached to the primary or secondary spiral. A first end of an elongate member may be attached to the primary or secondary spiral by a cylindrical hinge. A first end of an elongate member may be attached to the primary or secondary spiral by a universal joint.

A second end of an elongate member may be slide jointly attached to the primary or secondary spiral. The elongate member may be arranged such that the second end is free to move in a direction parallel to the longitudinal axis.

A second end of an elongate member may sit in a sliding guide attached to the primary or secondary spiral. The sliding guide may comprise a ‘U’-shaped member (or ‘C’-shaped member) providing a slot in which the second end of the elongated member is slideably disposed.

The first end of each elongate element may be pivoted on a first turn selected among the turns of the primary spiral and the turns of the secondary spiral, and the second end of the elongate element is preferably in sliding contact with a second turn selected among the turns of the secondary spiral and the turns of the primary coil spiral so that the position of the elongate element is modified in a controlled manner with reference to the longitudinal axis of the helical element by screwing or unscrewing the secondary spiral with respect to the primary spiral.

The screw conveyor may further comprise a plurality of slots disposed in the primary spiral and/or secondary spiral and a plurality of retaining pins, each retaining pin passing through a respective slot. The slots and retaining pins are arranged to guide rotation of the secondary spiral with respect to the primary spiral around the longitudinal axis. The slots are preferably arcuate. The slots are preferably angularly spaced around the spiral, for example, at least one every turn of the spiral. The slots may have an arc length of between 20° and 40°, preferably between 25° and 35°.

The screw conveyor may further comprise a stem coupled to (or “in communication with”) the secondary spiral which, when turned, causes the secondary spiral to rotate with respect to the primary spiral around the longitudinal axis. The stem preferably runs along the longitudinal axis. The screw conveyor may further comprise an actuator coupled to the stem for rotating the secondary spiral with respect to the primary spiral to a desired angular position and, once at the desired angular position, and for locking the secondary spiral at the desired angular position. The actuator may comprise a hydraulic adjustment device.

The screw conveyor may be employed in a drying apparatus that can be used in the treatment of multiple different substances, using perforated tubes with an internal screw (“spiral”) integral thereto in order to advance the substances to be treated from an inlet to an outlet of the drying apparatus.

The elongate members can take the form of a bar or rod. The elongate members preferably span between a turn of the primary spiral and an adjacent, facing turn of the secondary spiral.

The substance to be dried may be a sludge. The sludge may be a paper sludge. The sludge may be a wastewater sludge.

The screw conveyor may be used in an apparatus which is not used for drying. Thus, the water content of the substance conveyed by and/or treated in the screw conveyor may not change or not substantially change. For example, the substance may be a substance to be fermented, such as a biomass, which can be used to provide food for human consumption or feedstock for animal consumption (e.g., domestic or farm animals).

The helical element, elongate members and other mechanical or moving parts of the screw conveyor may be formed from stainless steel. Some parts, particularly parts which are in contact with, slide along or move against another, such as hinges, joints or pivots, may be formed from bronze. The primary spiral, the secondary spiral and/or the elongate members, and/or hinges or joints may be encapsulated or coated in a plastic.

According to a second aspect of the present invention there is provided a fermentation system (or “fermentating apparatus” or “fermenter”) comprising at least one screw conveyor including the screw conveyor of the first aspect.

According to a third aspect of the present invention there is provided a drying apparatus comprising at least one screw conveyor including the screw conveyor of the first aspect.

According to a fourth aspect of the present invention there is provided a drying apparatus comprising a plurality of screw conveyors, each screw conveyor comprising the screw conveyor of the first aspect.

The drying apparatus may further comprise a support frame, a front head, a rear head, and a top wall. The drying apparatus may further comprise a hopper for receiving a substance to be dried through an inlet in the top wall, and a rotating cylindrical valve downstream of the hopper, in the proximity of the front head. The screw conveyors are rotatably supported on the front head and rear head, and are provided on the rear head with sprockets and driver(s) for advancing a substance to be dried up to an outlet from the apparatus. The drying apparatus may further comprise a heated air system adapted to feed heated air to the plurality of screw conveyors so as to dehydrate a substance to be dried, wherein the drying apparatus is arranged to allow moist air to escape through openings in the top wall.

The screw conveyors may be arranged in a column, one above one another, wherein a first, lower screw conveyor comprises a helical element arranged inside a trough, wherein a second, intermediate screw conveyor and a third, upper screw conveyor have respective helical elements, whose primary spiral is rigidly connected to a perforated tube, which surrounds the helical element, and is integrally rotatable therewith.

The screw conveyors in the column may be housed in a shell or shells which is/are provided with openings and adapted to convey the heated air, wherein the heated air system comprises at least one supply tube, secondary tubes, at least one conveyor box supported by the support frame and adapted to supply heated air inside the shell or shells directly to the intermediate screw conveyor and the upper screw conveyor through the openings.

The shell or shells may have identical facing projections to form a prismatic housing, and the perforated tubes have longitudinal fins projecting outwardly and adapted to interact with the facing projections to retain the heated air in the prismatic housings before exiting as moist air through the openings.

The driver(s) may comprise a geared motor mounted on the rear head and connected to the sprockets by means of a flexible transmission member. The driver(s) may comprise a plurality of geared motors, each geared motor arranged to drive a respective sprocket. The drying apparatus may further comprise a plurality of hygrometers mounted proximate to the screw conveyors, for example, mounted on the shell(s).

According to a fifth aspect of the present invention there is provided a system for use with the drying apparatus of the third or fourth aspect, the system comprising a dehydrated waste incinerator, a first fan for supplying air from the outside, a heat exchanger on one side downstream of the dehydrated waste incinerator and on the other side, downstream of the first fan, for supplying heated air to the drying apparatus, a pelletizer downstream of the outlet from the drying apparatus for the substance to be dried and upstream of the incinerator, a condenser for humid air exiting the drying apparatus at the expense of mains water entering through a branch, from the condenser exiting a first tube for the waste water, and a second tube for the water returning to the mains water, a second fan downstream of the condenser for the recirculation of fumes within the drying apparatus, and a fume purifier adapted to receive cooled air from the condenser, as an alternative to recirculation, and fumes from the heat exchanger, wherein a tube exits the purifier for the waste water.

The drying apparatus may be operable to have a variable flow rate and constant number of revolutions. The drying apparatus may be operable to a fixed flow rate and variable number of revolutions. The drying apparatus may be operable to have an automatically-variable degree of mixing at a constant flow rate. The drying apparatus may have separate chambers with variable humidity. The drying apparatus may be operable to reverse flows which can allow its overall dimensions to be reduced. The drying apparatus may be configured to have cyclonic, vertical and horizontal warm air currents. The drying apparatus may have hot air currents with an adjustable flow rate and a forced path in order to control the falling speed of the product to be dried. The drying apparatus may be operable to provide energetic or extremely gentle mixing depending on the substances to be treated.

The drying apparatus can provide for the adoption of screw spirals cooperating with a perforated support tube, on whose internal wall they are attached. The plurality of holes, up to and including micrometer-sized holes, is present in the tube over a large part of its length and their dimensions are such that they do not allow the substance to be dried to leak. There are primary screw spirals flanked by secondary screw spirals that can be screwed or unscrewed onto the primary screw spirals, and controlled from the outside of the equipment. Between a primary and a second spiral loop facing one another, elongated elements are mounted, whose inclinations are adjustable with respect to the longitudinal axis of the screw through a relative rotation of the secondary spiral with respect to the primary spiral. The elongated elements may be in the form of straight or vanes otherwise configured.

The drying apparatus can improve performance in terms of contact time between the air and the substance to be dried, mixing by adjusting the rotation speed of the screws and the angle of the elongated elements, which can be tilted between the primary and secondary spiral, and the air supply by choosing directions and paths. The end result is a drying apparatus which can increase or maximise the dry percentage yield obtainable with an equal amount of energy input, or, decrease or minimise the amount of energy input with an equal percentage of dry obtained. Energy savings of between 20 and 40 percent may be obtainable depending on the nature of the substances to be dried.

The apparatus may be intended for drying water purification sludge and industrial sludge, but may also be applied in the agri-food industry for drying grains, pasta, semi-processed tubers for subsequent production of food flours, dried fruits, and more.

According to sixth aspect of the present invention there is provided a drying apparatus. The drying apparatus comprises a support frame, a front head, a rear head, and a top wall, a hopper for receiving a substance to be dried through an inlet in the top wall, and a rotatable cylindrical valve downstream of the hopper, near the front head. The drying apparatus comprises a plurality of screw conveyors which may be supported on the front head and rear head and equipped on the rear head with toothed crowns and drive means for moving a substance to be dried through the drying apparatus up to its outlet from the apparatus. Each screw conveyor includes a helical element which has a longitudinal axis x and is equipped with a plurality of turns, at least one elongate member having two ends, of which a first end is positioned on a first turn of the helical element and a second end is positioned on a second turn facing the first turn. The drying apparatus comprises a heated air system suitable for feeding heated air to the plurality of lower screw conveyors, intermediate screw conveyors, and upper screw conveyors for dehydration of the substance to be dried, moist air escaping from the apparatus openings made in the top wall. Each helical element of the screw conveyor is formed by a primary coil and a secondary coil, having turns matching each other respectively, the first end of each elongate element being pivoted on a first turn selected among the turns of the primary coil and the turns of the secondary coil, and the second end of the elongate element being in sliding contact with a second turn selected among the turns of the secondary coil and the turns of the primary coil, so that the position of the elongate element is modified in a controlled manner with reference to the longitudinal axis x of the helical element, by screwing or unscrewing the secondary coil with respect to the primary coil.

The mutually-matching turns may be provided with corresponding slots and a retaining pin which passes through them so that the secondary coil is able to screw and unscrew on the primary coil, the secondary coil having one end connected to a secondary coil shaft adapted to be controlled from the outside of the front head.

The first end of the elongate element may be pivoted with a cylindrical hinge on a turn of the primary coil and said second end of the elongate element may be inserted in a sliding guide provided in a facing turn of the secondary coil.

The secondary coil shaft may be equipped with a lever adapted to be rotated manually and be locked once an arc of rotation of the lever corresponding to the desired position for the elongate element has been covered.

The secondary coil shaft may be configured in such a way as to be connected to a hydraulic adjustment device to be activated and locked once the arc of rotation corresponding to the position desired for the elongate element has been covered.

The screw conveyors may be arranged one above the other at least in a column, the lower screw conveyor being a helical element arranged at the inside of a trough, the intermediate screw conveyors and the upper screw conveyors having a helical element whose primary coil is rigidly connected to a perforated tube which surrounds the helical element and is rotatable integrally with it. The column of screw conveyors may be housed in a shell, provided with openings and adapted to convey the heated air, the heated air system comprising at least one supply pipe, secondary pipes, at least one conveyor box, which is supported by the support frame and is adapted to supply heated air inside the shells directly to the intermediate screw conveyors and upper screw conveyors through the openings provided on the shells. The shells may have identical facing projections to configure together a prismatic housing, and the perforated tubes have longitudinal fins projecting outward and adapted to cooperate with the facing projections to retain the heated air in the prismatic housings before exiting as moist air from the drying apparatus through the openings.

The means for driving the screw conveyors may comprise a gear motor, preferably a single gear motor, mounted on the rear head and simultaneously connected to the toothed crowns of the conveyors screw by means of a flexible transmission member.

The means for driving the screw conveyors may comprise a gear motor for each screw conveyor.

A plurality of hygrometers may be mounted on the shells near the screw conveyors.

According to a seventh aspect of the present invention there is provided a plant for the use of the drying apparatus, the plant comprising a dehydrated waste incinerator, a first fan for supplying air from the outside, a heat exchanger downstream, on one side, of the dry waste incinerator and on the other side, of the first fan, adapted to supply heated air to the drying apparatus, a pellet machine downstream of the outlet of the substance to be dried from the drying apparatus and upstream of the incinerator, a condenser for humid air leaving the drying apparatus at the expense of mains water (WR) entering through a branch, from the condenser exiting a first pipe for the waste water and a second pipe for the water returning to the mains water, a second fan downstream of the condenser for the recirculation of fumes in the drying apparatus, a fume purifier suitable for receiving cooled air from the condenser, as an alternative to recirculation, and fumes from the heat exchanger, a pipe exiting 30 the purifier for the waste water.

The equipment may be intended for drying foodstuffs, waste or other materials.

According to an eighth aspect of the present invention there is provided a system for the treatment of dehydrated sludge.

Screw conveyor equipment may be provided in which a substance to be dried is fed in at one end and the dehydrated substance is discharged at the other. Air flow or other type of heat transfer being performed is transmitted in a counter current. The speed of the screw, as well as its diameter and pitch, can be used to determine a rate of output (e.g., hourly output) and a degree of drying of the treated material.

### BRIEF DESCRIPTION OF THE DRAWINGS

Certain embodiments of the present invention will now be described, by way of example, with reference to the accompanying drawings, in which:

FIG. 1 is a perspective view of a drying apparatus;

FIG. 2 is an elevational view of a rear end of the drying apparatus shown in FIG. 1;

FIG. 3 is a perspective view of the drying apparatus shown in FIG. 1 without a supporting frame;

FIG. 4 is a perspective view of an internal part of the drying apparatus shown in FIG. 1;

FIG. 5 is a schematic horizontal section of the drying apparatus shown in FIG. 3;

FIG. 6 is a schematic vertical section of the drying apparatus shown in FIG. 3;

FIG. 7 is a schematic perspective view of screw conveyor shells of the drying apparatus shown in FIG. 6;

FIG. 8 is an exploded perspective view of the shells shown in FIG. 7;

FIG. 9 is a schematic perspective view of a screw conveyor shown in FIG. 4;

FIG. 10 is an enlarged partial schematic perspective view of an end of a screw conveyor shown in FIG. 3;

FIG. 11A is a schematic perspective view of a helical element of the screw conveyor shown in FIG. 9 viewed from a front left position;

FIG. 11B is a schematic perspective view of a helical element of the screw conveyor shown in FIG. 9 viewed from a front right position;

FIG. 12A is a first enlarged detail of the end of the helical element shown in FIG. 11A;

FIG. 12B is a first enlarged detail of the end of the helical element shown in FIG. 11B;

FIG. 13A is a second enlarged detail of the helical element shown in FIG. 11A in which elongated elements are in a first position;

FIG. 13B is a second enlarged detail of the helical element shown in FIG. 11B;

FIG. 13C is a third enlarged detail of the helical element shown in FIG. 11A in which elongated elements are in a second position;

FIG. 13D is an exploded enlarged detail of the end of the helical element shown in FIG. 11A;

FIG. 14A is an enlarged detail of the helical element shown in FIG. 11A viewed from above;

FIG. 14B is an enlarged detail of a helical element viewed from above in which elongated elements are in a different position;

FIG. 15A shows an enlarged detail of a helical element viewed from above in a first position;

FIG. 15B shows an enlarged detail of the helical element of FIG. 15A viewed from above in a second position;

FIG. 15C shows an enlarged detail of the helical element of FIGS. 15A and 15B viewed from above in a third position;

FIG. 16 is a partial perspective view of a front end of a drying apparatus having a variant of a drive;

FIG. 17 is a partial perspective view of a rear end of a drying apparatus having a variant of a drive; and

FIG. 18 is a schematic diagram of a system using a drying apparatus.

### DETAILED DESCRIPTION OF CERTAIN EMBODIMENTS

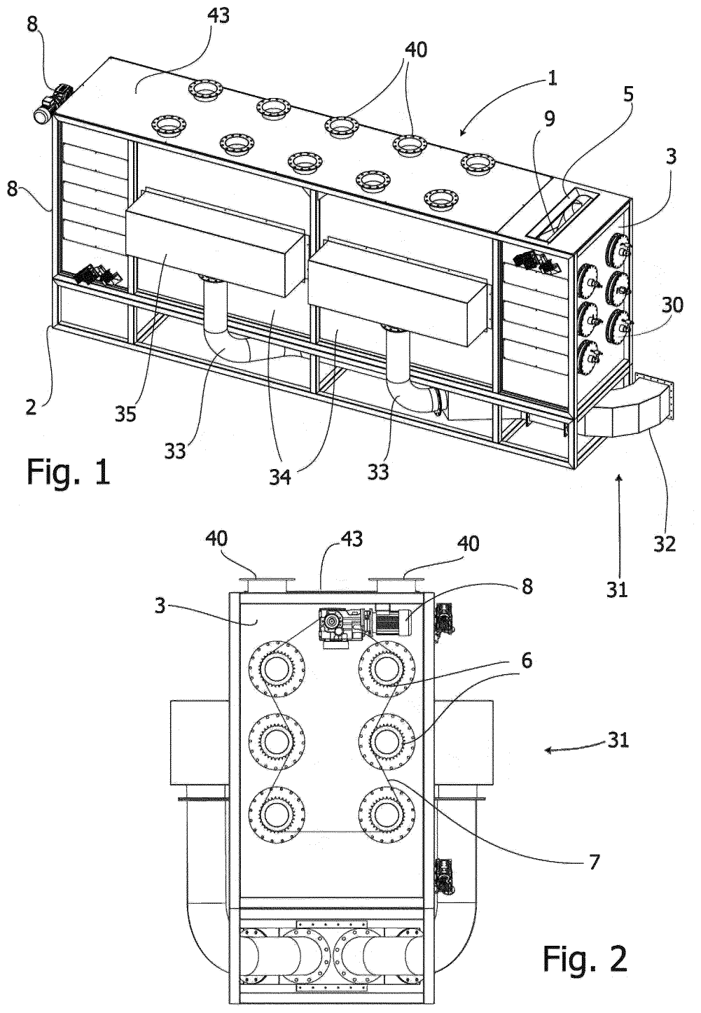

Referring to FIG. 1, a drying apparatus 1 is shown.

The drying apparatus 1 comprises a support frame 2, a front head end 3 and a rear head end 4, a top wall 43 and a hopper 5 for receiving a substance to be dried through an opening on the top wall 43 proximate to the front head end 3. A rotating cylindrical valve 9 is disposed below the hopper 5, i.e., downstream of the hopper 5. The top wall 43 is provided with openings 40 for allowing moist air to escape from inside the drying apparatus 1.

Referring also to FIGS. 2, 3 and 4, the rear head end 4 of the drying apparatus 1 has a set of drives (or “drivers”) for a plurality of screw conveyors 90, 91, 92 which are rotatably supported on the front head end 3 and rear head end 4. Respective sprockets 6 are mounted on the end of the screw conveyors 90, 91, 92 (best shown in FIG. 4). The screw conveyors 90, 91, 92 are arranged in two columns. In this case, there are three screw conveyors in each column, namely a lower screw conveyor 90, an intermediate screw conveyor 91 and an upper screw conveyor 92. The intermediate screw conveyor 92 is interposed between the lower and upper screw conveyors 90, 92.

There may, however, be more screw conveyors. For example, there may be more columns and/or there may be more screw conveyors in each column.

The sprockets 6 are connected by a flexible transmission member 7 in the form of a chain to a drive means in the form of a geared motor 8 and are arranged to drive the screw conveyors 90, 91, 92 simultaneously. The motor 8 drives the screw conveyors 90, 91, 92 to cause a substance to be dried to cascade to an outlet (not shown) of the drying apparatus 1.

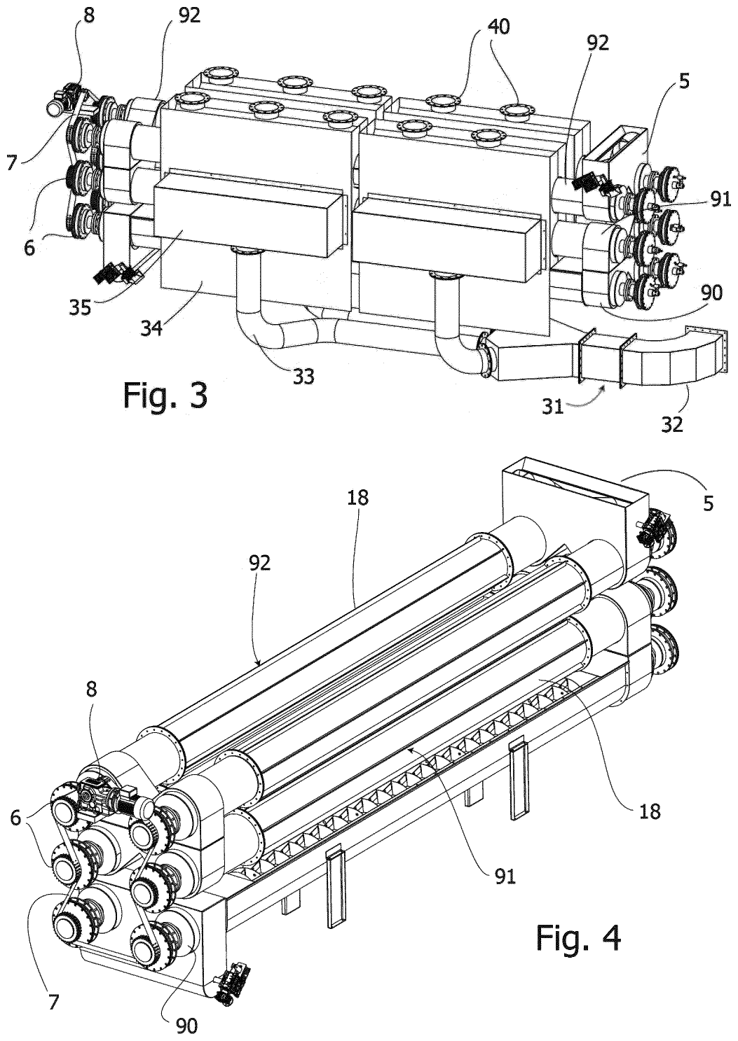

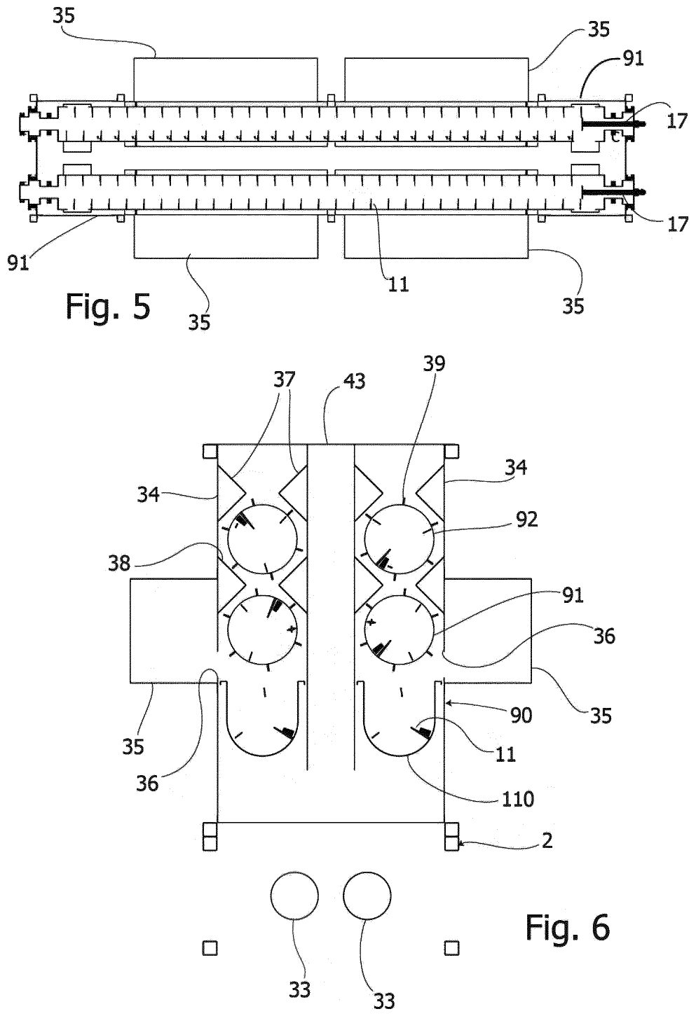

Referring to FIGS. 3, 4, 5 and 6, the lower screw conveyors 90 comprise a helical element 11 (or “screw blade assembly”), preferably with a central stem, and a trough 110.

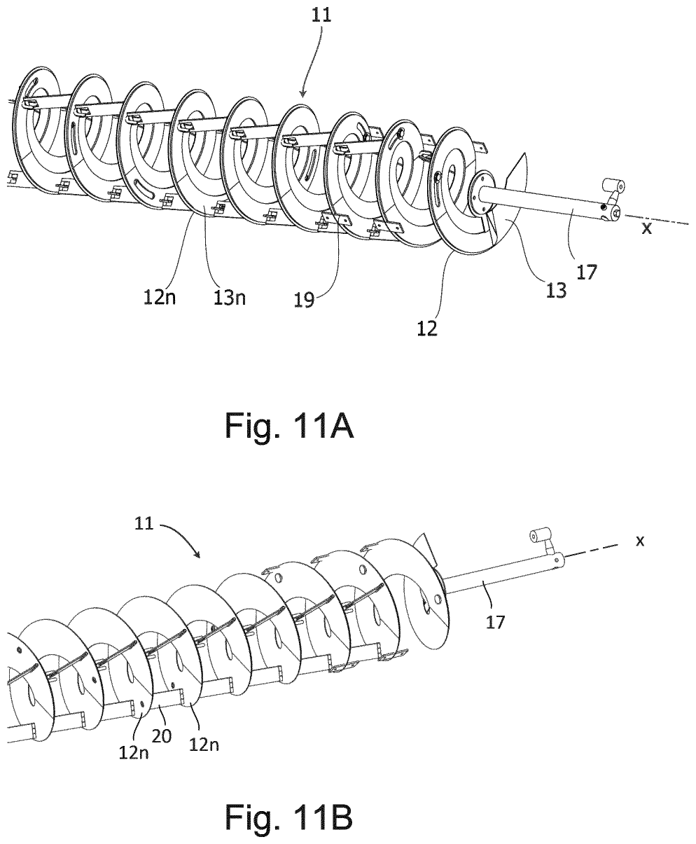

Referring also to FIGS. 11A and 11B, the helical element 11 having a longitudinal axis x is formed by a primary spiral 12 (herein also referred to as a “first spiral”, “first coil” or “first screw”) and a secondary spiral 13 (herein also referred to as a “second spiral”, “second coil” or “second screw”) having mutually matching loops 12n, 13n (herein also referred to as “screw blades”). The helical element 11 may be formed from stainless steel or other suitable material. The helical element 11 may be coated, for example, by a plastic. The primary spiral 12 has primary loops 12n and the secondary spiral 13 has secondary loops 13n, where n indicates a loop number (e.g., 1, 2, . . . , N). The loops 13n of the secondary spiral 13 are adapted to rest in contact with the loops 12n of the primary spiral 12. Expressed differently, the loops 13n of the secondary spiral 13 abut the loops 12n of the primary spiral 12.

The primary and second spirals 12, 13 are intertwined. The primary and second spirals 12, 13 are coaxial.

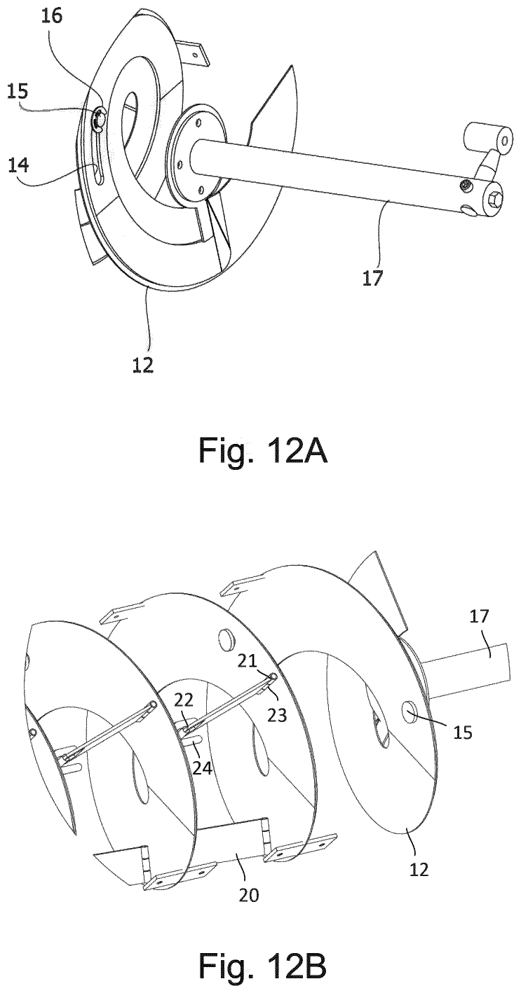

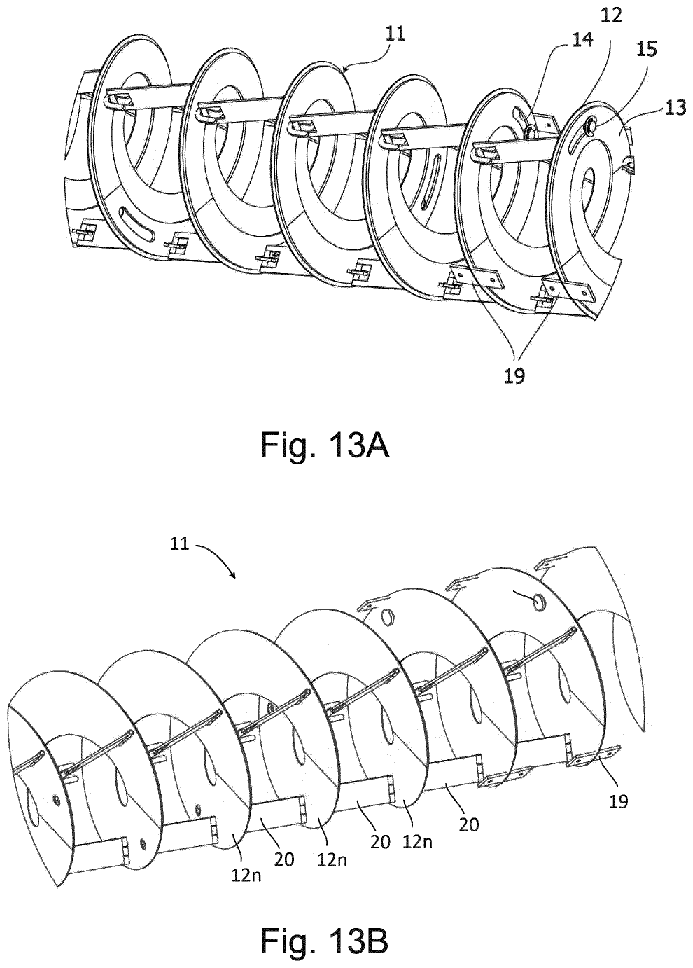

Referring also to FIG. 12A, the matching loops 12n, 13n are provided with corresponding slots 14. A retaining pin 15, passing through the corresponding slots 14 of the loops 12n, 13n, retains (or “holds”) the secondary spiral 13 against the primary spiral 12 by means of a snap ring 16. Thus, the secondary spiral 13 may be screwed and unscrewed on the primary spiral 12 of the arc allowed by the slot 14 and the retaining pin 15.

As will be explained in more detail hereinafter, the secondary spiral 13 has a distal end which is connected to a secondary spiral stem 17 which is controllable from outside the front end 3 of the drying apparatus 1. A rigid connection between the stem 17 and the secondary spiral 13 is schematically shown in FIG. 12A.

The primary spiral 12 in each screw conveyor 90, 91, 92 is rotated by the geared motor 8 via the sprockets 6 and the flexible transmission member 7.

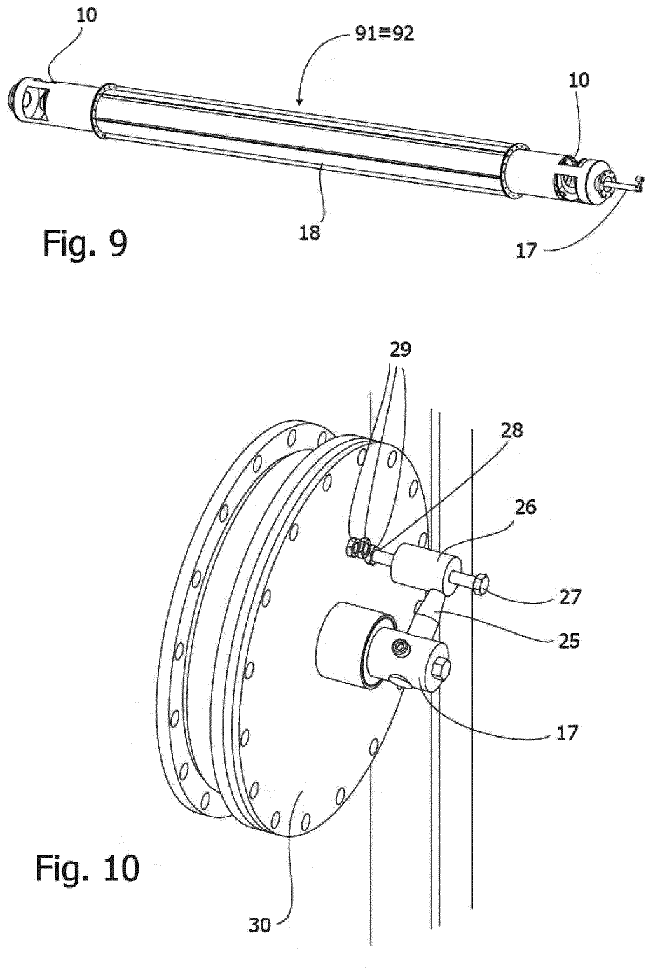

Referring to FIG. 9, the intermediate and upper screw conveyors 91, 92 differ from the lower screw conveyors 90 in that they are encased in a tube 18 (i.e., they are “intubated”). These conveyors 91, 92 have no central stem and the primary spiral 12 is joined to a perforated tube 18 surrounding the helical element 11.

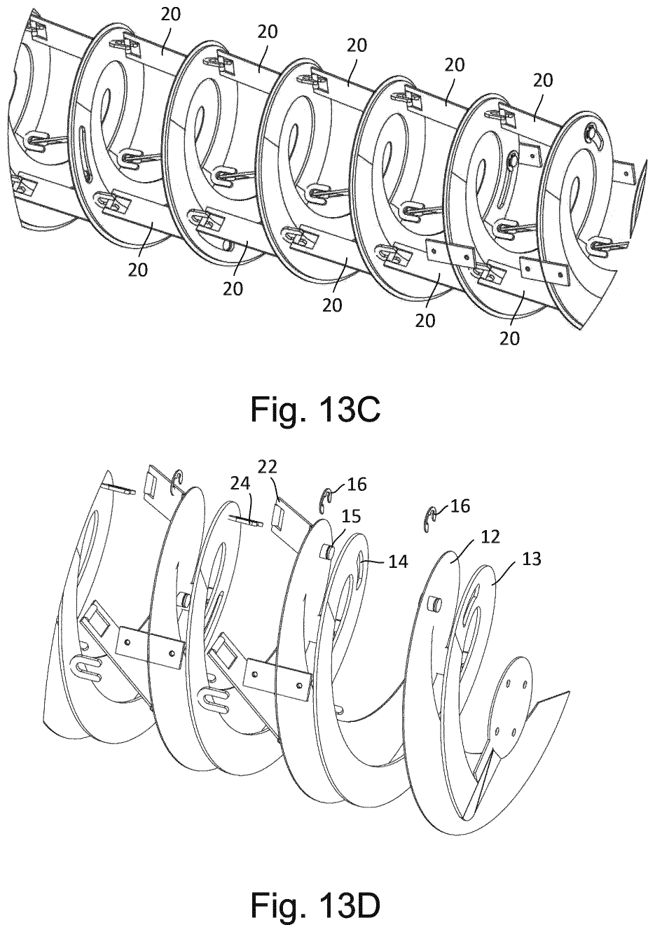

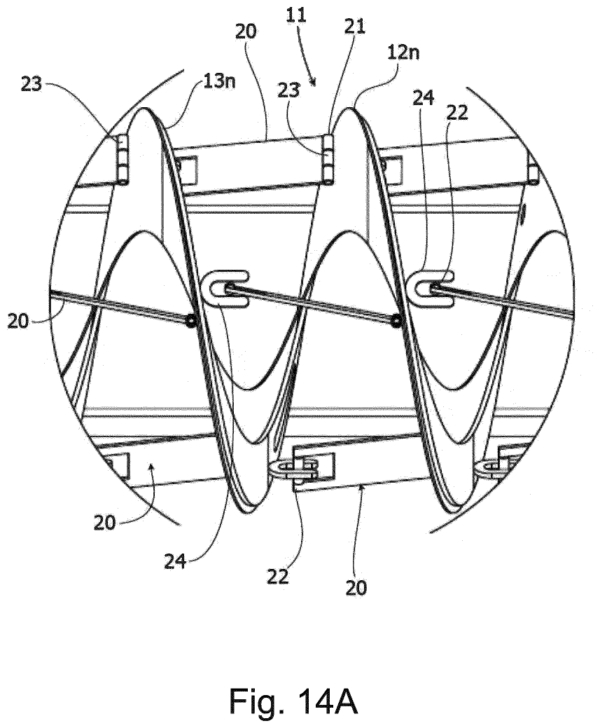

Referring also to FIG. 13A, a joint 19 between the primary spiral 12 and the perforated tube 18 is implemented, for example, by welded bars (or “plates”).

A to-be-dried substance (not shown) is cascaded from the opening of the receiving hopper 5 to the upper and lower screw conveyors 92, 90, passing through the intermediate screw conveyors 91, via end openings 10 in the ends of the intermediate and upper screw conveyors 91, 92.

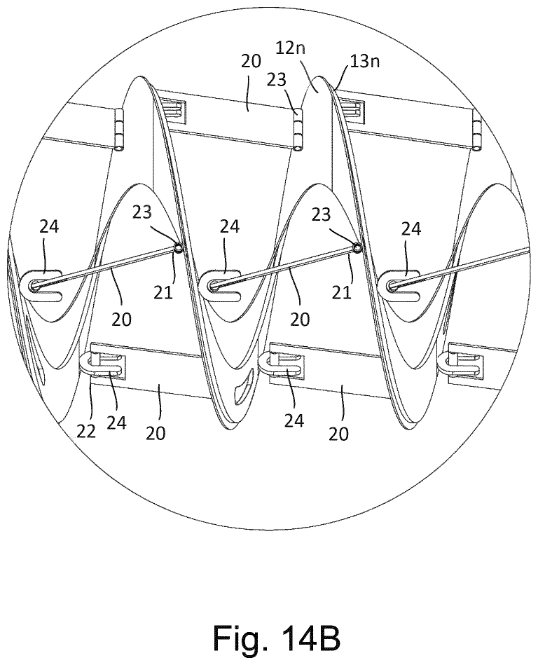

Referring to FIG. 14A, each loop 12n of the primary spiral 12 is connected to a loop 13n of the secondary spiral 13 by means of at least one elongated element 20.

In this example, each pair of loops 12n, 13n is joined by three elongated elements 20 (or “elongate members”) spaced apart by 120° around each loop 12n, 13n. The elongated elements 20 may be formed from stainless steel or other suitable material. The elongated elements 20 may be coated, for example, with a plastic. The elongated elements 20 take the form of vanes. Each elongated element 20 may have a shape that differs from that of a vane. For example, an elongated element 20 may be curved, twisted or differently shaped. Each elongated element 20 has first and second ends 21, 22. A first end 21 is positioned on a loop 12n of the primary spiral 12 and a second end 22 is positioned on a second consecutive loop 13n of the secondary spiral 13.

The first end 21 of the elongated element 20 is pivoted on the first loop 12n of the primary spiral 12 and the second end 22 of the elongated element 20 is in sliding contact with the second loop 13n of the secondary spiral 13. As a result of this configuration, the position of each elongated element 20 with respect to the longitudinal axis x of the helical element 11 may be modified in a controlled fashion.

The first and second ends 21, 22 of each element 20 may be tethered, restrained or attached to the spirals 12, 13 in other ways.

The first end 21 of the elongated element 20 may be pivoted by means of a cylindrical hinge 23 on a loop 12n of primary spiral 12, and the second end 22 of the elongated element 20 may be inserted in a sliding guide 24 provided on a facing loop 13n of the secondary spiral 13. The guide 24 takes the form of a ‘U’-shaped (or ‘C’-shaped) member which provides a slot (or “fork”) in which the second end 22 of the elongated member 20 can sit and slidably move. The second end 22 may include a roller to help facilitate movement of the second end 22 of the member 20. The elongated member may be provided with some other arrangement (e.g., a slide or a piston) which allows movement in a direction parallel to the longitudinal axis. The cylindrical hinge 23 may alternatively be provided on a loop 13n of secondary spiral 13, and the sliding guide 24 on a facing loop 12n of primary spiral 12.

The rotation allowed by the slot 14 and the retaining pin 15 changes the spatial position of all the elongated elements 20 between each pair of loops 12n of the primary spiral 12 and loops 13n of the secondary spiral 13 simultaneously.

Referring in particular to FIG. 12A, screwing and unscrewing of the secondary spiral 13 with respect to the primary spiral 12 may be performed manually by means of the secondary spiral stem 17.

Referring also for FIG. 10, the stem 17 of the secondary spiral 13 is provided with a lever 25, which is integral with the stem 17 and is manually rotatable. The lever 25 carries on its free end a guide sleeve traversed by a pointer 27. The pointer 27 is preferably a spring-loaded stem, which may be positioned with its tip 28 inside a seat made of a screw nut from a plurality of screw nuts 29 welded onto a front end 30 of screw conveyor 90 (FIG. 6).

By means of the lever 25, when rotated the desired arc of circumference and positioned by the pointer 27 in the cavity of the nut 29 corresponding to the desired rotation of the secondary spiral 13 with respect to the primary spiral 12, it is possible to achieve the desired position of the elongated elements 20.

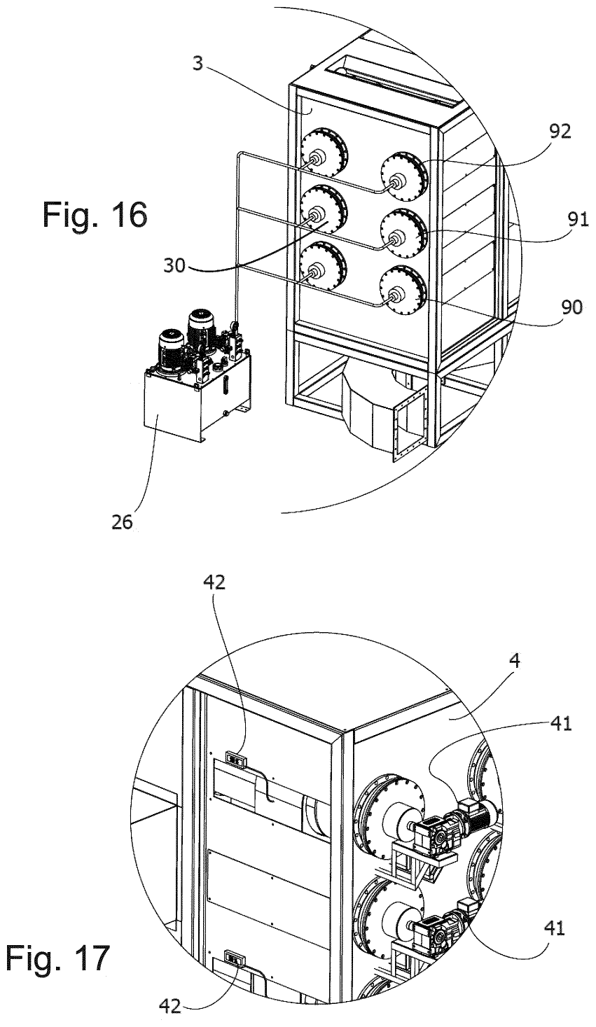

Referring to FIG. 16, as an alternative to manual operation of the secondary spiral stem 17, the latter can be configured on its free end to be connected to a hydraulic adjustment device 26 for actuation and locking, once the angle of rotation corresponding to the desired position of the elongated element 20 has been reached.

The hydraulic device 26 is connected to individual actuators which are applied to the respective stems 17 of the spiral 13 of the screw conveyors.

Referring again to FIG. 1, the drying apparatus 1 comprises a heated air system 31 adapted to supply heated air to the plurality of screw conveyors for dehydrating the substance to be dried and for treating the moist air at the outlet. The air supply portion of the system 31 includes the general supply tubing 32 that branches off with secondary tubing 33 to reach the shells 34 enclosing the columns of the screw conveyors 90, 91, 92.

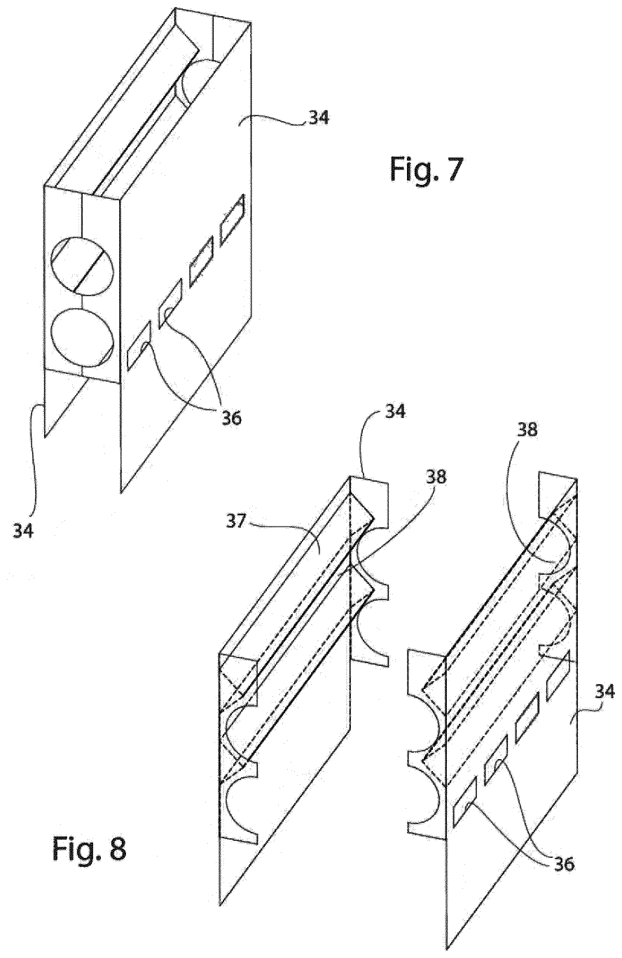

Referring again to FIGS. 7 and 8, the shells 34 of the screw conveyors are shown in more detail. Conveyance boxes 35 are provided between the secondary tubes 33 and the shells 34 to distribute the heated air within the shells 34. To this end, the shells 34 have openings 36 that allow heated air to be conveyed into the shells 34.

Referring also to FIG. 6, the heated air supply system 31, which includes the general supply tubing 32, secondary tubing 33, shells 34 and conveyor boxes 35, is supported by the support frame 2 and is adapted for supplying heated air within the shells 34 directly to the intermediate and upper screw conveyors 91, 92 through openings 36 provided on the shells 34. The openings 36 are arranged inferiorly of the intermediate screw conveyors 91, such that the heated air does not disturb the advancement of the now dehydrated substance present in the lower screw conveyors 90 to be dried. The pressure with which the heated air is advanced does not impact on the intermediate and upper conveyors 91, 92, in that the perforated tube 18 surrounding them has hole dimensioned such that the substance to be dried does not leaked out.

Referring still to FIG. 6, the shells 34 have identical facing projections 37 in order to jointly configure a prismatic housing 38, and the perforated tubes 18 have outwardly projecting longitudinal fins 39 adapted to cooperate with the facing projections 37 to retain the heated air in the prismatic housing 38 prior to its exit as moist air from the drying apparatus through the openings 40 (FIGS. 1, 2 and 3).

As mentioned hereinbefore, the drive means of the screw conveyors comprise a single geared motor 8 mounted on the rear head end 4 of the drying apparatus 1 and simultaneously connected to the sprockets 6 of the screw conveyors 90, 91, 92 via the flexible transmission member 7.

Referring to FIG. 17, the drive means of the screw conveyors 90, 91, 92 may comprise a respective geared motor 41 for each conveyor.

A plurality of hygrometers 42 are mounted in proximity to the screw conveyors 90, 91, 92. The hygrometers 42 allow for the evaluation of the moisture in the various sections of the screw conveyors. These hygrometers make it possible to decide the position of the elongated elements 20, which become established due to their inclination with respect to the longitudinal axis x of the helical element 11 of each screw conveyor. This can help ensure the permanence of the substance to be dried in the various sections of the screw conveyors and its degree of mixing.

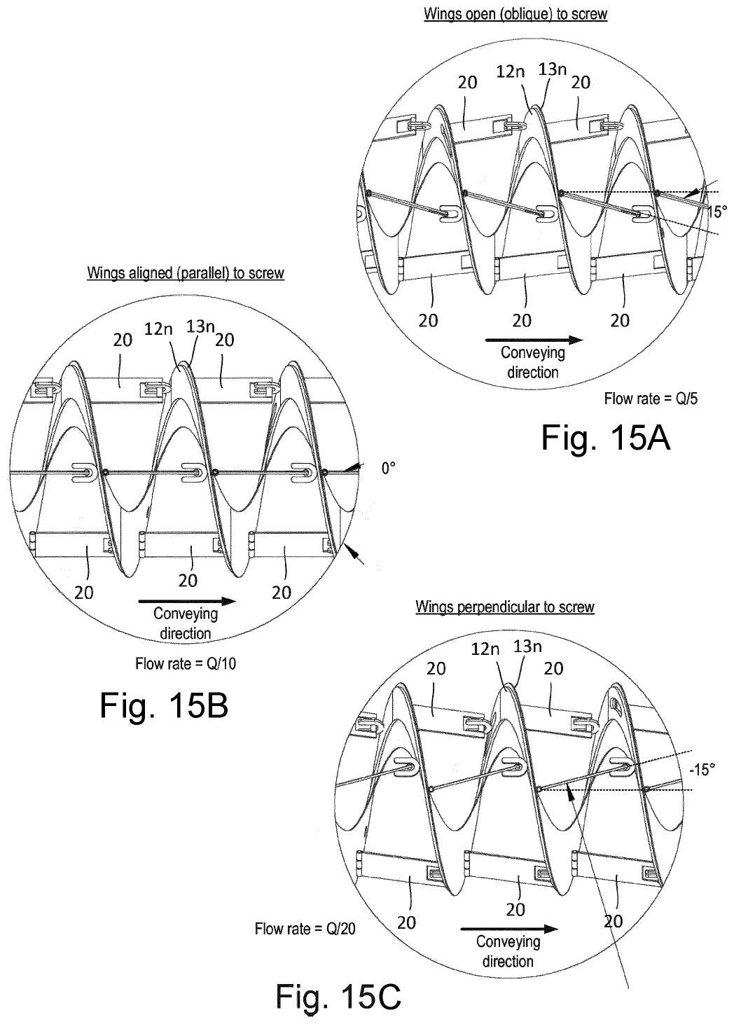

FIG. 15 illustrates three different angles of inclination of the elongated elements 20 with respect to the longitudinal axis x, namely 0°, ˜15° and +15°. Other different angles of inclination are possible with the range −15° and +15°. Angles of inclination beyond −15° and +15° may be possible.

If Q is the flow rate of material using the helical element 11 without elongated elements operating a given speed, then the flow rate of material can be controllable reduced by feathering the elongated elements 20, in other words, by varying the angle of inclination of the elongated elements 20. If elongated elements 20 are used and are aligned to the helical element 11 (i.e., are parallel to the longitudinal axis), then the flow fate is Q/10. The rate may be increased or decreased. For example, if the elongated elements 20 are angled at −15° resulting in the elongated elements 20 being perpendicular to the surfaces of the helical element 11, then the flow rate is reduced to Q/20. Conversely, if the elongated elements 20 are angled at +15°, then the flow rate is increased to Q/5. The values of flow rates may depend on the composition and/or the nature of the material. For example, a more compact material (e.g., a drier material) may flow more quickly, i.e., have a higher flow rate, compared with the same material which is less compact (e.g., a wetter material).

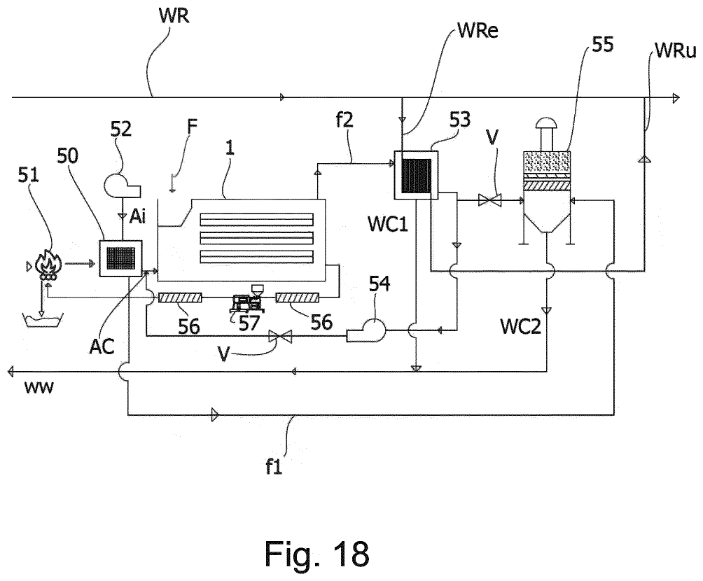

Referring to FIG. 18, a schematic representation of a wastewater treatment system employing the drying apparatus 1 herein described is shown. There, the drying apparatus is denoted by 1. A heat exchanger 50 is located downstream of a waste incinerator 51 on one side and a first fan 52, on the other. The heat exchanger 50 is located upstream of the drying apparatus 1. A condenser exiting the drying apparatus 1 is denoted by 53, a second fan, by 54, and a flue gas purifier, by 55. WR denotes a network of water passing through the condenser 53 with a first branch WRe, and exiting therefrom with a second branch WRu. Condensed water WC1 joins condensate WC2 from the flue-gas purifier 55 to form waste water WW. A gaseous cycle comprises incoming air Ai supplied from the outside via the first fan 52, which enters the drying apparatus 1 as Ac, when heated by the incinerator 51.

Dried sludge is introduced along the arrow F, and dewatered sludge exits a screw conveyor and is transported to a waste incinerator 51, which is also fed by pellets. The fumes f2 leave the drying apparatus 1 and enter the condenser 53, where they divide in amounts controlled by the respective valves V in order to reach the fume purifier 55. The fumes f2 emanating from the first heat exchanger 50 arrive at the same purifier 55. The system cycle starts with the dewatered sludge having a dry percentage between 23-28% entering the drying apparatus 1 along the arrow F through the rotating hoppers. This mechanism allows the sludge to be loaded, but not for the hot process air to escape.

Thus, the sludge mass positioned at the beginning of the screw conveyors is vigorously mixed and transported very slowly to the end of the first sections to be loaded into the second reverse-flow sections.

During the “back-and-forth” process, the mass undergoes progressive drying due to the transfer of humidity into the hot air flow. The exchange surface between the mass to be dried and the air flow is fundamental to the efficiency of the system. The screw conveyors simultaneously allow for a number of revolutions per minute to vary between 0.1-50 and above, while still maintaining the established flow rate due to the presence of the elongated elements, whose longitudinal angle is adjustable. This makes possible energetic mixing. Moreover, it allows special configurations of the aerodynamic flows and the adoption of venturi tubes, via the screws, as well as fluidization of the mass being dried, while placing the system in the states of a floating bed, thus determining the maximum exchange surface.

The fact that the bottom screw conveyors are not intubated and integral, but have a central shaft and are rotating on a trough, avoids spillage or entrainment of the dried product in the upper aerodynamic flows.

The sludge thus dried is placed in the bottom rotating hoppers, and from there transported to the incinerator 51 via the screw conveyors 56 and pelletizer 57. A variable number of pellets (8-12%) with a significantly lower calorific value is added thereto in order to maintain a permanent flame temperature above 800° C.

The heat thus produced is transferred to the drying apparatus via an airflow heated by the heat exchanger 50. The hot air flow is provided by the fan 54 located downstream of the drying apparatus 1. The hot air f2, loaded with humidity, before being recirculated in a percentage varying from 0 to 100%, passes through the condenser 53, from which the condensates, loaded with derived substances, are extracted and returned to the head of the drying apparatus 1, or for alternative use.

The non-recirculated air in the system, and the exhaust fumes from the burner are treated by the air purifier 55, which consists of a wet cyclone, a fluidized bed trap, a counter-current percolator tower, a lamellar pack degasser and an activated carbon adsorption tower.

The system can be fully controlled by means of a computer system at relevant focal points, in particular in terms of managing the inlet flow rate, varying the revolutions per minute of the screw conveyors, varying the humidity gradient inside the sections of the circuit, the necessary air flows, and varying the angle and regulation of the elongated elements. The system can thus be adapted to different operating conditions and has maximum efficiency.

Modifications

It will be appreciated that various modifications may be made to the embodiments hereinbefore described. Such modifications may involve equivalent and other features which are already known in the design, manufacture and use of systems which include screw conveyors and component parts thereof and which may be used instead of or in addition to features already described herein. Features of one embodiment may be replaced or supplemented by features of another embodiment.

The system need not be a drying system, but can be another form of system, such as a fermentation system, for example in the form of a screw bioreactor.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1.-21. (canceled)

22. A screw conveyor comprising:
a helical element having a longitudinal axis and comprising:
a primary spiral comprising a plurality of turns; and
a secondary spiral comprising a plurality of turns, mounted on the primary spiral and rotatable with respect to the primary spiral around the longitudinal axis;
a set of elongate members spanning the primary and secondary spirals.

23. The screw conveyor of claim 22, wherein a first end of each elongate member is hingedly attached to a one of the primary spiral or the secondary spiral.

24. The screw conveyor of claim 22, wherein a first end of each elongate member is attached to a one of the primary spiral or the secondary spiral by a cylindrical hinge.

25. The screw conveyor of claim 22, wherein a second end of each elongate member is slide-jointly attached to a one of the primary spiral or the secondary spiral.

26. The screw conveyor of claim 22, wherein a second end of each elongate member sits in a sliding guide attached to a one of the primary spiral or the secondary spiral.

27. The screw conveyor of claim 26, wherein the sliding guide comprises a ‘U’-shaped member providing a slot in which the second end of the elongated member is slideably disposed.

28. The screw conveyor of claim 22, further comprising
a plurality of slots disposed in the primary spiral and/or the secondary spiral;
a plurality of retaining pins, each pin passing through a respective slot(s);
wherein the slots and pins are arranged to guide rotation of the secondary spiral with respect to the primary spiral around the longitudinal axis.

29. The screw conveyor of claim 22, further comprising:
a stem coupled to the secondary spiral which, when turned, causes the secondary spiral to rotate with respect to the primary spiral around the longitudinal axis.

30. The screw conveyor of claim 29, further comprising:
an actuator coupled to the stem for rotating the secondary spiral with respect to the primary spiral to a desired angular position and, once at the desired angular position, and for locking the second screw blade at the desired angular position.

31. The screw conveyor of claim 30, wherein the actuator comprises a hydraulic adjustment device.

32. A fermentation system comprising at least one screw conveyor including the screw conveyor of claim 22.

33. A drying apparatus comprising at least one screw conveyor including the screw conveyor of claim 22.

34. A drying apparatus comprising a plurality of screw conveyors, each screw conveyor comprising the screw conveyor of claim 22.

35. The drying apparatus of claim 34, further comprising:
a support frame;
a front head, a rear head, and a top wall;
a hopper for receiving a substance to be dried through an inlet in the top wall, and a rotating cylindrical valve downstream of the hopper, in proximity of the front head;
wherein the screw conveyors are rotatably supported on the front head and rear head, and provided on the rear head with sprockets and driver(s) for advancing a substance to be dried up to an outlet from the apparatus;
the drying apparatus further comprising:
a heated air system adapted to feed heated air to the plurality of screw conveyors so as to dehydrate a substance to be dried, wherein the drying apparatus is arranged to allow moist air to escape through openings in the top wall.

36. The drying apparatus of claim 35, wherein the screw conveyors are arranged in a column, one above one another, wherein a first, lower screw conveyor comprises a helical element arranged inside a trough, wherein a second, intermediate screw conveyors and a third, upper screw conveyor have respective helical elements, whose primary spiral is rigidly connected to a perforated tube, which surrounds the helical element, and is integrally rotatable therewith.

37. The drying apparatus of claim 36, wherein the screw conveyors in column are housed in a shell or shells which is/are provided with openings and adapted to convey the heated air, wherein the heated air system comprises at least one supply tube, secondary tubes, at least one conveyor box supported by the support frame and adapted to supply heated air inside the shell or shells directly to the intermediate screw conveyor and the upper screw conveyor through the openings.

38. The drying apparatus of claim 37, wherein the shell or shells have identical facing projections to form a prismatic housing, and the perforated tubes have longitudinal fins projecting outwardly and adapted to interact with the facing projections to retain the heated air in the prismatic housings before exiting as moist air through the openings.

39. The drying apparatus of claim 34, wherein the driver(s) comprise a geared motor mounted on the rear head and connected to the sprockets by means of a flexible transmission member.

40. The drying apparatus of claim 34, wherein the driver(s) comprises a plurality of geared motors, each geared motor arranged to drive a respective sprocket.

41. The drying apparatus of claim 34, further comprising:
a plurality of hygrometers mounted proximate to the screw conveyors.

42. A system for use with the drying apparatus of claim 33, the system comprising:
a dehydrated waste incinerator;
a first fan for supplying air from the outside;
a heat exchanger on one side downstream of the dehydrated waste incinerator and on the other side, downstream of the first fan, for supplying heated air to the drying apparatus;
a pelletizer downstream of the outlet from the drying apparatus for the substance to be dried and upstream of the incinerator;
a condenser for humid air exiting the drying apparatus at the expense of mains water entering through a branch, from the condenser exiting a first tube for the waste water, and a second tube for the water returning to the mains water;
a second fan downstream of the condenser for the recirculation of fumes within the drying apparatus; and
a fume purifier adapted to receive cooled air from the condenser, as an alternative to recirculation, and fumes from the heat exchanger, wherein a tube exits the purifier for the waste water.
